(19) United States
(12) Patent Application Publication
(10) Pub. No.: US 2026/0220744 A1
(43) Pub. Date: Jul. 30, 2026

(54) APPARATUS FOR PROCESSING A MEDICAL IMAGE

(71) Applicant: KONINKLIJKE PHILIPS N.V., EINDHOVEN (NL)

(72) Inventors: Sergey Kastryulin, Moscow (RU); Christian Wuelker, Hamburg (DE)

(21) Appl. No.: 19/141,366

(22) PCT Filed: Dec. 12, 2023
(86) PCT No.: PCT/EP2023/085248

§ 371 Date: Jun. 20, 2025

(30) Foreign Application Priority Data
Dec. 22, 2022 (RU) 2022133893

(51) Int. Cl. G06T 5/50; G06T 3/4038; G06T 3/4046; G06T 5/60; G06T 5/70; G06T 5/73; G06V 10/26

(52) U.S. Cl. CPC G06T 5/50; G06T 3/4038; G06T 3/4046; G06T 5/60; G06T 5/70; G06T 5/73; G06V 10/26; G06T 2207/10081; G06T 2207/10088; G06T 2207/10104; G06T 2207/10108; G06T 2207/10132; G06T 2207/20021; G06T 2207/20081; G06T 2207/20084; G06T 2207/20192; G06T 2207/20212; G06T 2207/30004; G06V 2201/03

(57) ABSTRACT

The invention refers to providing an apparatus that allows to provide images, e.g. MR images, with an improved quality when processed utilizing CNNs. A providing unit (111) provides an image. Another providing unit (112) provides a machine learning based processing model. The processing model is a CNN and configured to use a valid convolution resulting in a loss of voxels at margins of a resulting processed image. A patch image generation unit (113) generates patch images, wherein the patch images are split such that the patch images overlap at the margins by an amount of voxels equal to the amount of voxels lost at the margins during the valid convolutions. An image generation unit (114) generates a processed image by applying the processing model to each of the patch images, respectively, and combining the resulting providing processed patch images to the processed image.

### FIELD OF THE INVENTION

The invention refers to an apparatus, a method and a computer program product for processing a medical image. Further, the invention refers to a system for processing a medical image comprising the apparatus. Moreover, the invention refers to a training apparatus, a training method and a training computer program product for training the processing model utilizable in the apparatus, method and/or computer program product for processing the medical image.

### BACKGROUND OF THE INVENTION

Today, for processing medical images, in particular, for improving the quality of a medical image, for example, for reducing image artifacts or improving spatial resolution, or analyzing a medical image, for instance, segmenting a part of an anatomy in the medical image, often machine learning methods, in particular, convolutional neural networks are utilized. However, at present all methods of dealing with the huge amounts of data that a medical image can present, for instance, in case of a three-dimensional CT image or MRI image, when utilizing machine learning algorithms either lead to a restriction in the applicability of the method, for instance, due to high computational costs, or introduce specific image artifacts that can even decrease the quality of the medical image. Thus, it would be advantageous if a medical image could be processed utilizing convolutional neural networks while avoiding processing artifacts and at the same time keeping the applicability, in particular, the computational costs, low.

### SUMMARY OF THE INVENTION

It is an object of the present invention to provide an apparatus, a method and a computer program product that allow for processing medical images utilizing convolutional neural networks such that the quality of the processed medical images is improved. Further, it is an object to keep the necessary computational resources reasonable such that the method can also be applied to 3D or 4D images. Moreover, it is further an object of the invention to provide an apparatus, a method and a computer program product that allow to provide a processing model that can be utilized in the above context.

In a first aspect of the invention, an apparatus is presented for processing a medical image, wherein the apparatus comprises a) an image providing unit for providing a medical image of a region of interest of a patient, b) a model providing unit for providing a machine learning based processing model, wherein the processing model is a convolutional neural network and configured to process an input medical image resulting in a processed medical image when the processing model is applied to the input medical image, wherein the processing model is configured to use as part of the convolutional neural network a valid convolution resulting in a loss of voxels at margins of a resulting processed medical image compared to a respective input medical image, c) a patch image generation unit for generating patch images based on the medical image, wherein the medical image is split into patch images such that the patch images overlap at the margins by an amount of voxels equal to the amount of voxels lost at the margins during the valid convolutions used by the processing model, d) an image generation unit for generating a processed medical image by applying the processing model to each of the patch images, respectively, resulting in processed patch images and combining the resulting processed patch images to the processed medical image.

Since the convolutional neural network utilizes a valid convolution and is applied patch-wise, wherein the medical image is split into patch images such that the patch images overlap at the margins by an amount of voxels equal to the amount of voxels lost at the margins during the valid convolutions, the patch-wise processed medical image can be stitched together without stitching or convolution artifacts. Moreover, since the patch-wise application of the convolutional neural network to the medical image is provided, the computational resources for performing the processing of the medical image can be kept within reasonable limits by adapting the patches accordingly.

Generally, the apparatus is configured for processing a medical image. The apparatus can be realized in any form of hardware and/or software provided by a general or dedicated computer system. In particular, the apparatus can also be realized in distributed computing, for example, can be realized as part of a computer network in which the functions of the apparatus are provided by different processors, servers or computer systems. The medical image can refer to any two-dimensional or three-dimensional medical image. Moreover, the medical image can also refer to a 4D medical image, for instance, a time series of 3D medical images. Preferably, the medical image refers to any of a magnetic resonance image (MRI), a computed tomography (CT) image, a single-photon emission computed tomography (SPECT) image, a positron emission tomography (PET) image and an ultrasound (US) image. The processing of the medical image can refer to any processing that utilizes a convolutional neural network. In particular, the processing of the medical image can refer to a quality enhancement and/or an analysis of the medical image. A quality enhancement generally enhances some aspect of the quality of the medical image. In particular, it is preferred that a quality enhancement refers to any of a de-noising, a de-blurring, an increase of resolution, an artifact correction and a contour enhancement. The analysis of the medical image can refer to any analysis that extracts one or more aspects of the medical image for further processing, for instance, for validation by a user. Preferably, an analysis of the medical image refers to at least one of segmentation, medical labelling, and path extraction. Generally, medical labeling refers to some kind of classification of content provided by a medical image and can refer, for instance, to tissue labeling, anatomical labeling, body-type labeling, etc.

The medical image providing unit is configured for providing a medical image of a region of interest of a patient. Generally, the medical image providing unit can refer to a storage unit or can be communicatively coupled to a storage unit, wherein the medical image is already stored on the storage unit and the medical image providing unit is configured for providing the medical image stored on the storage unit, for instance, for further processing to the patch image generation unit. Further, the medical image providing unit can also be a receiving unit for receiving the medical image, for instance, from an input unit or via an interface directly from a medical image acquisition unit, for instance, a CT unit, and for providing the received medical image. Moreover, the medical image providing unit can also be regarded as the medical image acquisition unit or a part of the medical image acquisition unit that is directly configured for providing the medical image.

The model providing unit is configured for providing a machine learning based processing model. For example, also the model providing unit can be or can be communicatively coupled to a storage unit on which the processing model is already stored. Further, the model providing unit can also refer to a receiving unit for receiving the processing model, for instance, from a user input unit or from an interface connected to a training apparatus for training a respective processing model. The model providing unit can then be configured for providing the machine learning based processing model, for instance, to the image generation unit.

The processing model is a convolutional neural network and is further configured to process an input medical image resulting in a processed medical image when the processing model is applied to the input medical image. Generally, convolutional neural networks are a specialized type of artificial neural networks that utilize a convolution in at least one of the neural network layers. Preferably, the processing model is a fully-convolutional neural network. This has the advantage that mathematically a patch-wise and a non-patch-wise application of the processing model to an image lead to equivalent results, i.e. the result is equivalent for an application to the whole image and a patch-wise application. However, also a not-fully convolutional neural network can be utilized to advantage in some cases. In this invention, the processing model is configured to use as part of the convolutional neural network a valid convolution resulting a loss of voxels at margins of a resulting processed medical image compared to a respective input medical image. Generally, a valid convolution is a type of convolution operation that does not use any padding before the application of the convolution to an input matrix such that the size of the input matrix to which the valid convolution is applied is reduced in contrast to utilizing a padded convolution in which the size of an input matrix, for instance, an image, is the same as the size of the output matrix. However, utilizing a valid convolution has the advantage of not utilizing values not present in the image itself, in particular, of not utilizing padding values for the padding operation. Generally, a neural network in case of padded convolution can be trained to ignore the padded values to some degree leading to adequately accurate results. However, this additional task increases the computational resources used by the neural network and, since in most cases these computational resources are limited, can lead to a loss of accuracy in other parts of the network. Thus, the results provided by the valid convolution are more accurate and only take into account the actual values of the input medical image.

The patch generation unit is configured for generating patch images based on the medical image. In particular, the medical image is split into patch images such that the patch images overlap at the margins by an amount of voxels equal to the amount of voxels lost at the margins during the valid convolutions used by the processing model. In particular, the medical image is split into patch images such that the patch images together cover all or a predetermined part, for instance, a region of interest, of the medical image. The number and size of patch images, for instance, the voxel width, height and depth can be predetermined, for instance, based on the size of the patch image with which the processing model has been trained. Generally, the amount and size of the patch images can depend on the size and/or the resolution of the medical image. The overlap at the margins of the patch images is determined based on the amount of voxels lost at the margins during the valid convolutions of the utilized processing model. These amounts of voxels can easily be calculated based on predetermined knowledge about the valid convolutions used by the processing model and can be stored, for instance, together with the processing model on a storage such that it is available for the patch image generation unit when generating the patch images. Splitting the medical image in this way and generating the patch images based on the pre-knowledge about the valid convolutions that are performed by the processing model allows in the following steps to generate the processed medical image without quality loss due, for instance, to overlap errors or pattern convolution inaccuracies.

The image generation unit is configured for generating a processed medical image by applying the processing model to each of the patch images respectively resulting in processed patch images. The processed patch images are then combined to the processed medical image. Preferably, the combining of the resulting processed patch images to the processed medical image comprises stitching the processed patch images together, wherein each processed patch image is provided at the position of the respective generated patch image in the medical image. Moreover, it is preferred that the stitching of the processed patch images is performed without an overlap of the processed patch images. This becomes possible due to the utilization of the valid convolution and at the same time of determining the patch images with a respective overlap.

In an embodiment, the processing of the medical image refers to a quality enhancement and the processing model is configured for enhancing the quality of the medical image with respect to at least one of the following enhancement aspects de-noising, de-blurring, increase of resolution, artifact correction, and contour enhancement.

In an embodiment, the processing refers to analysing the medical image and the processing model is configured for analysing the medical image with respect to at least one of the following aspects: segmentation, medical labelling, path extraction.

In a further aspect of the invention, an apparatus is presented for training a machine learning based processing model usable for processing of a medical image, wherein the apparatus comprises a) a training data providing unit configured for providing training data comprising i) a plurality of images and ii) processed images associated with each of the plurality of images, b) a model providing unit for providing a machine learning based processing model, wherein the processing model is a convolutional neural network and trainable to processing an input image resulting in a processed image when the processing model is applied to the input image, wherein the processing model is configured to use as part of the convolutional neural network a valid convolution resulting in a loss of voxels at margins of a resulting processed image compared to a respective input image, c) a training unit for training the provided machine learning based processing model based on the training data, d) a model providing unit for providing the trained processing model. The training images can generally be any images, in particular, if the processing model if trained for image quality enhancement. Neural networks have the general possibility to be trained such that they can be applied also to images comprising content not used during the training. However, it is preferred that for a medical application also medical images are used for training. This allows to adapt the processing model very specifically for the characteristics of medical images.

In a further aspect of the invention, a method is presented for processing a medical image, wherein the method comprises a) providing a medical image of a region of interest of a patient, b) providing a machine learning based processing model, wherein the processing model is a convolutional neural network and configured to process an input medical image resulting in a processed medical image when the processing model is applied to the input medical image, wherein the processing model is configured to use as part of the convolutional neural network a valid convolution resulting in a loss of voxels at margins of a resulting processed medical image compared to a respective input medical image, c) generating patch images based on the medical image, wherein the medical image is split into patch images such that the patch images overlap at the margins by an amount of voxels equal to the amount of voxels lost at the margins during the valid convolutions used by the processing model, d) generating a processed medical image by applying the processing model to each of the patch images respectively resulting in processed patch images and combining the resulting processed patch images to the processed medical image. The method is a computer-implemented method.

In a further aspect of the invention, a training method is presented for training a machine learning based processing model usable for processing of a medical image, wherein the method comprises a) providing training data comprising i) a plurality of images and ii) processed images associated with each of the plurality of images, b) providing a machine learning based processing model, wherein the processing model is a convolutional neural network and trainable to processing an input image resulting in a processed image when the processing model is applied to the input image, wherein the processing model is configured to use as part of the convolutional neural network a valid convolution resulting in a loss of voxels at margins of a resulting processed image compared to a respective input image, c) training the provided machine learning based processing model based on the training data, d) providing the trained processing model. The method is a computer-implemented method.

In a further aspect of the invention, a system is presented for processing a medical image, wherein the system comprises a) a medical image acquisition apparatus, for acquiring a medical image, and b) an apparatus as described above.

In a further aspect, a computer program product is presented for enhancing the quality of a medical image, wherein the computer program product comprises program code means for causing the apparatus as described above to carry out the method as described above.

In a further aspect, a computer program product for training a machine learning based quality enhancement model usable for enhancing the quality of a medical image, wherein the computer program product comprises program code means for causing the apparatus as described above to carry out the method as described above.

It shall be understood that the apparatuses as described above, the methods as described above, the system as described above, and the computer program products as described above, have similar and/or identical preferred embodiments, in particular, as defined in the dependent claims.

It shall be understood that a preferred embodiment of the present invention can also be any combination of the dependent claims or above embodiments with the respective independent claim.

These and other aspects of the invention will be apparent from and elucidated with reference to the embodiments described hereinafter.

### BRIEF DESCRIPTION OF THE DRAWINGS

In the following drawings:

FIG. 1 shows schematically and exemplarily a system for processing a medical image,

FIG. 2 shows schematically and exemplarily a flowchart of a method for processing a medical image,

FIG. 3 shows schematically and exemplarily a flowchart of a method for training a processing model,

FIG. 4 shows schematically and exemplarily the problem solved by the present invention,

FIG. 5 shows schematically and exemplarily checkerboard artifacts resulting from a state of the art learning based approach of medical image processing,

FIG. 6 shows schematically and exemplarily a comparison between computing times of an algorithm according to the present invention with an algorithm according to the state of the art.

### DETAILED DESCRIPTION OF EMBODIMENTS

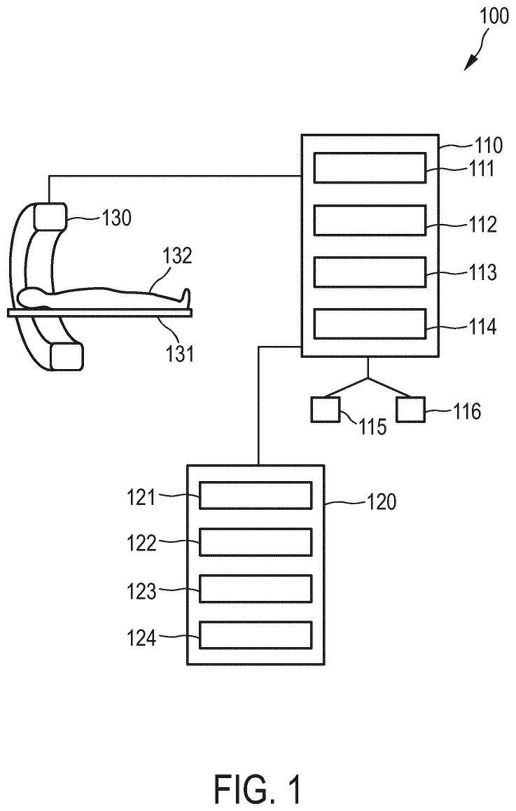

FIG. 1 shows schematically and exemplarily a system 100 for processing a medical image. The system comprises an apparatus 110 for processing the medical image and a medical image acquisition unit 130 for acquiring the medical image. Optionally, the system 100 further comprises a processing model training apparatus 120 for training the processing model utilized in the apparatus 110.

The image acquisition unit 130 can refer to any apparatus that allows to acquire a medical image. For example, the image acquisition unit can refer to a CT unit or MRI unit acquiring a medical image of a region of interest on a patient 132 lying on patient support 131. The acquired medical image can then be stored on a respective storage unit or directly sent to, for instance, an interface of apparatus 110.

The apparatus 110 can be realized as a general or a dedicated software and/or hardware, in particular, the apparatus 110 can also be realized in a distributed computing. The apparatus 110 comprises an image providing unit 111, a model providing unit 112, a patch image generation unit 113 and an image generation unit 114. The image providing unit 111 is configured for providing the medical image of the region of interest of the patient 132 acquired by the image acquisition unit 130. For example, the image providing unit 111 can be configured to access a storage on which the medical image is already stored. However, the image providing unit 111 can also be realized, for instance, as an interface for receiving from the image acquisition unit 130 the acquired medical image directly. For example, the image providing unit 111 can then provide the medical image for further processing to the patch image generation unit 113.

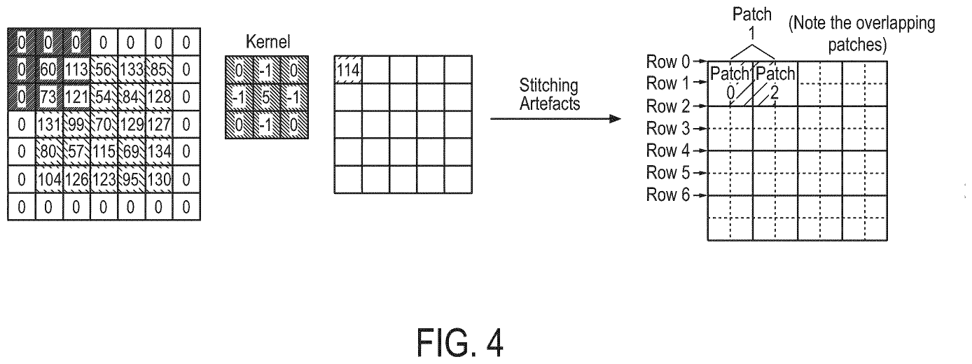

The model providing unit 112 is configured for providing a machine learning based processing model for processing the medical image. For example, the processing model can be stored on a respective storage unit that can be accessed by the model providing unit 112. However, the model providing unit 112 can also directly receive the processing model from a training apparatus for training the processing model like training apparatus 120. The processing model comprises a convolutional neural network and is configured to process an input medical image resulting in a processed medical image. In particular, the processing model is configured to use as part of the convolutional neural network a valid convolution which results in a loss of voxels at margins of a resulting processed medical image compared to a respective input medical image. This loss of voxels at margins when utilizing a valid convolution is explained in more detail with respect to FIG. 4 with respect to a specific application of the processing model. Generally, the processing model can be any model utilized for processing the medical image that utilizes a convolutional neural network. Such processing models are in particular utilized for quality enhancement like for de-noising, resolution enhancement, contour enhancement, etc., or for medical image analysis like anatomical structure segmentation, tissue labelling, etc. Thus, the processing model can refer to an image enhancement model or to an image analysis model.

The patch image generation unit 113 is configured for generating patch images based on the medical image. Patch images refer to parts of the medical image and are generated such that the medical image is split into the patch images. In particular, the splitting is performed such that the patch images overlap at the margins by an amount of voxels equal to the amount of voxels lost at the margins during the valid convolution used by the processing model. Since the voxel loss at the margins due to the valid convolution utilized by the processing model can be predetermined, it can, for instance, be stored together with the processing model and then utilized by the patch image generation unit for generating the patch images.

The image generation unit 114 is then configured for generating a processed medical image by applying the processing model to each of the patch images. The processing model then generates based on each of the patch images, a processed patch image, for instance, a patch image with an enhanced quality, and the image generation unit 114 is configured for combining the resulting processed patch images again to a processed medical image. In particular, the processed patch images are combined by directly stitching together the processed patch images without any overlap at the respective positions of the patch images in the medical image. Since the generated patch images were generated comprising an overlap, wherein the valid convolution of the processing model results in a processed patch image in which exactly the overlap is lost, the processed patch images fit together neatly and no stitching or overlap artifacts are generated.

The apparatus 110 can further comprise an input unit 115, for instance, a keyboard, mouse, touchscreen, etc. and an output unit 116, for instance, a display, wherein the processed medical image can then be provided by the image generation unit 114 to the output unit 116, for example, for displaying the processed medical image on the display.

The optional training apparatus 120 is configured for training a machine learning based processing model as used by the apparatus 110. For this aim, the training apparatus comprises a training data providing unit 121, a model providing unit 122, a training unit 123 and a model providing unit 124. The training data providing unit 121 is configured for providing training data for training a respective machine learning based processing model, in particular, a convolutional neural network. The training data comprises a plurality of images. Generally, any image can be used for training the processing model, in particular, if the processing model is trained as a quality enhancement model and the respectively trained processing model can then also be applied to medical images with good results. However, preferably for medical applications also medical images are utilized, for instance, a plurality of CT images or MRI images of the same region of interest in a patient or of different regions of interest in a patient, in particular, from different patients. Further, the training data comprises associated processed images referring, for instance, to medical images showing the desired processing characteristics. For example, for training a quality enhancement, in particular, a de-noising model, processed medical images for different regions of interests and/or for different types of these regions of interest can be generated, for instance, based on phantoms, anatomical knowledge, anatomical atlas images, etc. Based on these processed medical images showing no noise, medical images can be artificially generated by adding a noise as expected by the respective imaging modality. Training data for training a data analysis model, for instance, a segmentation model for segmenting an anatomical structure, can be generated by providing a plurality of medical images of a particular anatomical structure from different patients and/or from different perspectives and the processed medical images can be generated, for instance, using known segmentation algorithms or, for example, also by segmenting the medical images by hand by an expert.

The model providing unit 122 is then configured for providing a respective machine learning based processing model as described above with respect to apparatus 110. The training unit 123 is then configured for training the provided machine learning based processing model based on the training data. For example, known training algorithms like steepest gradient methods can be utilized for parametrizing, i.e. training, the processing model. During the training, also patch images can be generated and utilized for training the provided machine learning based processing model. However, in some cases the training can also be performed without generating the patch images. For example, the general de-noising of a medical image can be independent from the region shown by the medical image to which the respective processing model is applied such that the respective processing model can also be trained independent of the patch images. In case of a segmentation model, however, it might be more suitable in the training to also utilize the same patch image generation for training the segmentation model than is later utilized by the apparatus 110. The model providing unit 124 is then configured for providing the trained processing model, for instance, to a respective storage unit that can then be accessed by the apparatus 110 or to directly provide the trained processing model to the apparatus 110.

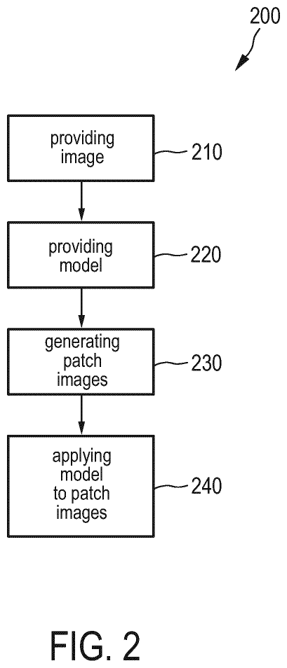

FIG. 2 shows schematically and exemplarily a method for processing a medical image. The method 200 is a computer implemented method and can be performed, for instance, by the apparatus 110 of FIG. 1, for instance, by executing a respective program code. The method comprises a step 210 of providing a medical image of a region of interest of a patient. Further, the method 220 comprises a step of providing a machine learning based processing model, for instance, as described above in more detail with respect to FIG. 1. In particular, steps 210 and 220 can be performed in any order or even at the same time. Further, the method comprises a step 230 of generating patch images based on the medical image. In particular, the medical image is split into patch images such that the patch images overlap at the margins by an amount of voxels equal to the amount of voxels lost at the margins during the valid convolutions used by the processing model. In a last step 240, a processed medical image is then generated by applying the processing model to each of the patch images respectively resulting in processed patch images and combining the resulting processed patch images to the processed medical image.

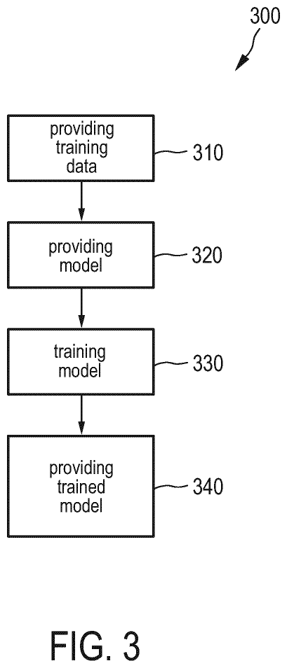

FIG. 3 shows schematically and exemplarily a flowchart of a method 300 for training a machine learning based processing model usable for processing the medical image. The method 300 is a computer implemented method that can be performed, for instance, by the apparatus 120 as described with respect to FIG. 1. In a first step, the method 300 comprises providing training data comprising a plurality of images, for instance, medical images, and processed images associated with each of the plurality of images, for instance, as described above with respect to FIG. 1. Further, the method comprises a step 320 of providing a machine learning based processing model as also described above. In particular, steps 310 and 320 can be performed in any order or even at the same time. Further, the method 300 comprises a step 330 of training the provided machine learning based processing model based on the training data using any known training algorithm for training a convolutional neural network. Moreover, the method 300 comprises in the last step 340 providing the trained processing model, for instance, for being utilized in the apparatus 110.

In the following, a more detailed description of a preferred embodiment of the application will be provided. Generally, the invention is related to the problem of processing medical images, in particular, of enhancing the quality of medical images, e.g., MRI, CT, PET/SPECT, US, etc. images. Quality enhancement is a broad term that typically describes the process of improving image quality (IQ) by improving characteristics such as signal-to-noise ratio (SNR), contrast-to-noise ratio (CNR), reducing/removing artefacts, improving spatial resolution, or improving a perceived sharpness, level of quality and detail on resulting images. IQ enhancement is an active research topic. Numerous publications are presented each year both in the general and medical domain. In particular, deep learning algorithms are proposed in this context. Thus, the majority of research papers and patents in the field are about training of IQ boost models. Patch-wise inference is often not discussed. This is related to the fact that in most cases volumetric data is considered as a set of 2D slices, which allows to use 2D IQ enhancement models. In 2D it is often, but not always, possible to apply a convolutional neural network to whole image, thereby rendering patch-wise inference often not necessary. Changing the representation format to 3D and using real 3D convolutional neural networks typically introduces engineering issues that need to be solved. In particular, most medical image modalities, e.g., MRI, CT, SPECT/PET, US, can be represented both as a stack of 2D images or as 3D volumes. Depending on a chosen representation format, appropriate IQ enhancement models can be applied. The 3D representation allows to use 3D models that typically provide higher quality results for the cost of increased computational complexity and memory footprint. There are several ways to deal with the increased demand of the hardware resources. The most commonly used method is described in the following.

Typically, modern 3D IQ enhancement models are convolutional neural networks trained with some form of gradient descent optimization algorithm. Due to high memory footprint, these models cannot be trained on whole volumes of data. Instead, small 3D patches of the respective image are used. A main idea of patch-wise inference is to use the same strategy when the model is applied, i.e., in model inference. A typical patch-wise algorithm can be described as follows. First a target volume, e.g. a medical image, is split into, optionally overlapping, patch images of manageable size for a convolutional neural network. The model is then sequentially or in parallel applied to all patch images and the resulting enhanced target volume, e.g. enhanced medical image, is obtained by combining the individually processed, optionally overlapping, patch images.

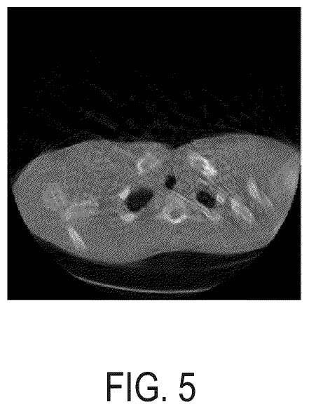

A main aspect of any convolutional neural network are the convolutional kernels combined into layers. On each convolutional layer, these kernels are sequentially multiplied with parts of the feature maps from the previous layer to obtain a single new value. If no additional transformations are done, this operation would lead to reduced resolution after each convolutional layer. However, in practice, it is often desired to preserve a size of the processed image or volume. To do that, so-called padded convolutions are used as illustrated in FIG. 4. Here, the feature map from the previous layer in padded in such a way that after being processed with the convolutional kernel it results in a new feature map of the same size While being convenient to implement convolutional neural network models with 3D images, the usage of padded convolutions has two severe side-effects during inference. Since convolutions are padded, in particular, often with “0” as padding value, which represents black colour on grayscale images, patch images obtained during inference have small black borders. After the patch images are combined, the resulting image typically has characteristic black stitching artefacts known as checkerboard artefacts as shown in the example in FIG. 5. To avoid checkerboard artefacts, inference with overlapping patches is typically used, for instance, as shown in FIG. 4. However, the overlap does not guarantee absence of stitching artefacts, it just makes them less evident. Moreover, it significantly increases the computational complexity of the resulting inference up to 1.5× compared to the overlap-free option. It would thus be advantageous if a respective algorithm could be found that allows for improving the image quality of medical images processed using convolutional neural networks, in particular, that allow to avoid respective patching artifacts.

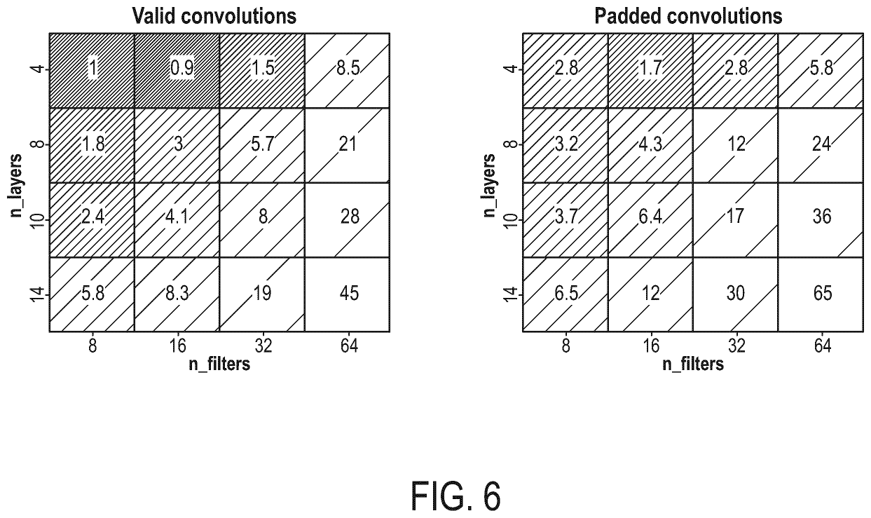

In this context the invention proposes, as described above, to use padding-free, i.e. valid convolutions, in combination with a specific inference strategy to make appearance of stitching artefacts mathematically impossible and reduce computational complexity. FIG. 6 shows schematically and exemplarily a comparison of compute time on a V 100 GPU for the same 3D convolutional neural network model topologies using padded and valid convolutions. Note approximately 1.5× performance boost for the largest considered topology with 14 layers, 64 filters.

To archive this a convolutional neural network architecture, e.g. 2D or 3D, is combined in this invention with a particular inference strategy to efficiently obtain artefact free resulting images. In particular, the invention is based on the insight that resolution reduction introduced by valid convolutions, which is typically considered as a disadvantage, can become a benefit if used correctly.

In a preferred embodiment, an apparatus according to the invention for processing a medical image utilizes a 2D or 3D convolutional neural network model architecture as processing model, for example, designed to solve an IQ enhancement problem, e.g., de-noising, super resolution, artefact correction etc., that uses valid convolutions as the main form of operation. Further a patch-wise inference strategy is used during inference to obtain a resulting version of the volume with improved IQ. In particular, the padded convolutions used by default in most deep learning frameworks are replaced with valid, i.e. padding-free convolutions. The convolutional neural network is then trained to solve the respective processing model, for instance, IQ enhancement problem at hand, in the patch-wise manner. The trained convolutional neural network model is then applied to the data to be enhanced, i.e. the medical image, using the following patch-wise inference strategy. In this strategy the inference is performed on overlapping patches, where the size of the overlap corresponds exactly to the number of pixels that are lost by the valid convolutions during inference, given the network architecture at hand. Afterwards, the non-overlapping patches can be stitched together neatly, i.e. without averaging or the like. This is computationally the fastest way to perform inference with limited GPU memory, while mathematically guaranteed to yield the same results as applying the convolutional neural network model to the whole volume, which is computationally typically not possible, due to memory limitations.

Other variations to the disclosed embodiments can be understood and effected by those skilled in the art in practicing the claimed invention, from a study of the drawings, the disclosure, and the appended claims.

In the claims, the word “comprising” does not exclude other elements or steps, and the indefinite article “a” or “an” does not exclude a plurality.

A single unit or device may fulfill the functions of several items recited in the claims. The mere fact that certain measures are recited in mutually different dependent claims does not indicate that a combination of these measures cannot be used to advantage.

Procedures like the providing of the medical image, the providing of the processing model, the generating of the patch images, the generating of the processed medical image, etc., performed by one or several units or devices can be performed by any other number of units or devices. These procedures can be implemented as program code means of a computer program and/or as dedicated hardware.

A computer program may be stored/distributed on a suitable medium, such as an optical storage medium or a solid-state medium, supplied together with or as part of other hardware, but may also be distributed in other forms, such as via the Internet or other wired or wireless telecommunication systems.

Any reference signs in the claims should not be construed as limiting the scope.

The invention refers to providing an apparatus that allows to provide images, e.g. MR images, with an improved quality when processed utilizing CNNs. A providing unit provides an image.

Another providing unit provides a machine learning based processing model. The processing model is a CNN and configured to use a valid convolution resulting in a loss of voxels at margins of a resulting processed image. A patch image generation unit generates patch images, wherein the patch images are split such that the patch images overlap at the margins by an amount of voxels equal to the amount of voxels lost at the margins during the valid convolutions. An image generation unit generates a processed image by applying the processing model to each of the patch images, respectively, and combining the resulting processed patch images to the processed image.

1. An apparatus for processing a medical image, wherein the apparatus comprises:
an image providing unit configured to provide a medical image of a region of interest of a patient,
a model providing unit configured to provide a machine learning based processing model, wherein the processing model is a convolutional neural network and configured to process an input medical image resulting in a processed medical image when the processing model is applied to the input medical image, wherein the processing model is configured to use as part of the convolutional neural network a valid convolution resulting in a loss of voxels at margins of a resulting processed medical image compared to a respective input medical image,
a patch image generation unit configured to generate patch images based on the medical image, wherein the medical image is split into patch images such that the patch images overlap at the margins by an amount of voxels equal to the amount of voxels lost at the margins during the valid convolutions used by the processing model,
an image generation unit configured to generate a processed medical image by applying the processing model to each of the patch images, respectively, resulting in processed patch images and combining the resulting processed patch images to the processed medical image.

2. The apparatus according to claim 1, wherein the combining of the resulting processed patch images to the processed medical image comprises stitching the processed patch images together, wherein each processed patch image is provided at the position of the respective generated patch image in the medical image.

3. The apparatus according to claim 2, wherein the stitching of the processed patch images is performed without an overlap of the processed patch images.

4. The apparatus according to claim 1, wherein the processing of the medical image refers to a quality enhancement and/or an analysis of the medical image.

5. The apparatus according to claim 1, wherein the processing of the medical image refers to a quality enhancement and the processing model is configured for enhancing the quality of the medical image with respect to at least one of the following enhancement aspects denoising, de-blurring, increase of resolution, artifact correction, and contour enhancement.

6. The apparatus according to claim 1, wherein the processing refers to analyzing the medical image and the processing model is configured for analyzing the medical image with respect to at least one of the following aspects: segmentation, medical labelling, path extraction.

7. The apparatus according to claim 1, wherein the medical image refer to any of an MRI image, a CT image, a SPECT image, a PET image, and a US image.

8. An apparatus for training a machine learning based processing model usable for processing of a medical image, wherein the apparatus comprises:
a training data providing unit configured to provide training data comprising a plurality of images and processed images associated with each of the plurality of images,
a model providing unit configured to provide a machine learning based processing model, wherein the processing model is a convolutional neural network and trainable to processing an input image resulting in a processed image when the processing model is applied to the input image, wherein the processing model is configured to use as part of the convolutional neural network a valid convolution resulting in a loss of voxels at margins of a resulting processed image compared to a respective input image,
a training unit configured to train the provided machine learning based processing model based on the training data,
a model providing unit configured to provide the trained processing model.

9. A method for processing a medical image, wherein the method comprises:
providing a medical image of a region of interest of a patient,
providing a machine learning based processing model, wherein the processing model is a convolutional neural network and configured to process an input medical image resulting in a processed medical image when the processing model is applied to the input medical image, wherein the processing model is configured to use as part of the convolutional neural network a valid convolution resulting in a loss of voxels at margins of a resulting processed medical image compared to a respective input medical image,
generating patch images based on the medical image, wherein the medical image is split into patch images such that the patch images overlap at the margins by an amount of voxels equal to the amount of voxels lost at the margins during the valid convolutions used by the processing model,
generating a processed medical image by applying the processing model to each of the patch images respectively resulting in processed patch images and combining the resulting processed patch images to the processed medical image.

10. A method for training a machine learning based processing model usable for processing of a medical image, wherein the method comprises:
providing training data comprising a plurality of images and processed images associated with each of the plurality of images,
providing machine learning based processing model, wherein the processing model is a convolutional neural network and trainable to processing an input image resulting in a processed image when the processing model is applied to the input image, wherein the processing model is configured to use as part of the convolutional neural network a valid convolution resulting in a loss of voxels at margins of a resulting processed image compared to a respective input image,
training the provided machine learning based processing model based on the training data,
providing the trained processing model.

11. A system for processing a medical image, wherein the system comprises:
a medical image acquisition apparatus, for acquiring a medical image, and
an according to claim 1.

12. A computer program product for enhancing the quality of a medical image, wherein the computer program product comprises program code stored on a non-transitory computer readable medium which when executed causes one or more processors to carry out the method of claim 9.

13. A computer program product for training a machine learning based quality enhancement model usable for enhancing the quality of a medical image, wherein the computer program product comprises program code stored on a non-transitory computer readable medium which when executed causes one or more processors to to carry out the method of claim 10.
